(19) United States
(12) Patent Application Publication
(10) Pub. No.: US 2016/0217226 A1
(43) Pub. Date: Jul. 28, 2016

(54) METHODS AND SYSTEMS FOR INFRASTRUCTURE PERFORMANCE: MONITORING, CONTROL, OPERATIONS, ANALYSIS AND ADAPTIVE LEARNING

(71) Applicant: Brian Westcott, Menlo Park, CA (US)

(72) Inventor: Brian Westcott, Menlo Park, CA (US)

(21) Appl. No.: 15/009,365

(22) Filed: Jan. 28, 2016

Related U.S. Application Data
(60) Provisional application No. 62/108,928, filed on Jan. 28, 2015.

(51) Int. Cl. G06F 17/50; G06F 9/455

(52) U.S. Cl. CPC G06F 17/5004; G06F 9/455

(57) ABSTRACT

A system for measuring, monitoring and controlling the performance of bridges and other infrastructure creates a database for analysis of real time performance and learning through adaptive algorithms allowing the performance to be analyzed over time and for changes in performance against the specific bridge or infrastructure and other bridges or infrastructure in the a network of such infrastructure.

### CROSS-REFERENCE TO RELATED APPLICATIONS

This application claims the benefit of Provisional No. 62/108,928 (Attorney Docket No. 47887-703.101), filed Jan. 28, 2015, the entire content of which is incorporated herein by reference.

### BACKGROUND OF THE INVENTION

1. Field of the Invention

The present invention relates generally to methods and systems for monitoring bridges, buildings, power transmission, pipelines, tunnels, roadways, and other infrastructure.

Bridge operation is providing the required functionality of capacity and safe, and secure transport over an obstacle connecting two geographical points for the entire life of the bridge in an economical manner.

Bridges are engineered designed structures built out of various materials including metal, and wood. Bridges are designed to function for a targeted life cycle that is normally about 50 years and designed for a set of operating parameters including level of traffic, weather and other conditions for that specific bridge. The design of a bridge is done so its performance will exceed the greatest required functionality with a factor of safety allowing it to meet the requirements of safe and secure transport for its entire life cycle. In the absence of future information on bridge functionality including changing requirements for capacity and actual use in the future adds additional requirements for a large factor of safety for the design of a bridge. In addition unknown factors will affect the life of a bridge including impact both minor and major from vehicles or boats colliding with the bridge structure, unknown flaws in construction and unexpected deterioration of materials over the life of the bridge will all add to the difference between performance of the operating bridge and the designed bridge.

Each bridge design is unique, but most are based on standardized design techniques and code requirements for engineering of civil structures. It is difficult to predict the performance of one bridge versus another because the unique design and operating parameters make each bridge a unique entity with regards to performance and operation. Therefore, measurement and prediction of the performance of bridges and other civil structures is very challenging. If real time information about the specific operating conditions of a specific bridge were available along with information about the condition of critical elements of the bridge structure, a better determination of the performance of the specific bridge could be analyzed and the performance and economics of bridge operation improved.

For all these reasons it is desirable to provide methods and systems for providing monitoring, control, operations and analysis on a real time basis in an economical manner for each individual bridge. The methods and systems would provide both central and local monitoring and control of conditions of individual bridges in real time as those bridges are in use. In addition the system would be able to respond in real time to safety issues and control access to the bridge. Individual analysis over time would allow for adaptive learning of the specific bridge condition and how it is changing based on how it responds to various disturbances and usage. Centralized information, utilizing learning techniques such as statistical pattern recognition, on a set of bridges would allow for operation of the network of bridges to maintain access to the geography the bridges support. Centralized monitoring and control would also improve the economics of bridge operations. Information on a network of bridges in a centralized database would increase the ability to analyze and compare similar bridges and bridges of different design to allow learning across the entire bridge network influencing real time performance and future bridge design.

2. Description of the Background Art

U.S. Pat. No. 4,179,940 describes systems and methods for monitoring bridge performance. U.S. Patent Publ. No. 2012/0283964 describes a wireless stress detector that is used in data gathering networks.

### SUMMARY OF THE INVENTION

The methods and systems according to the present invention provide for monitoring, control, operations and analysis on a real time basis using a local and centralized information and control system. Each bridge will be equipped or configured with a local monitoring and control unit that monitors and controls the conditions of the bridge. The unit will determine the bridge conditions including: structural integrity, weather conditions, traffic volume, type of traffic, type of use, safety, chemical levels, pollution, radiation levels and the like from sensors located on or at the bridge. The sensor information is measured and filtered then transmitted to the control unit where it can be stored locally then transmitted to the central unit. Specifically the invention relates to an information and control system that will monitor, control, operate and analyze a bridge or set of bridges improving their performance and reducing their lifecycle costs of operation.

Measurements include:
Bridge Structure Integrity
Strain
Acceleration
Crack/separation
Bridge movement
Impact
Weight
Vibration
Scour (Bridge foundation deterioration)
Safety
Bridge icing
Vehicle velocity/vehicle flow
Human intrusion or other intrusion
Weather
Wind
Temperature
Precipitation
Public safety
Bridge Lightening
Radiation
Chemical
License Plate Vehicle Monitoring
Pollution
CO
CO2
O3

Using these measurements the local control unit can determine safe operating conditions by analyzing the measurements against specific functional criteria stored in the controller and/or downloaded from the central information and control. If an out of function condition is determined the local controller can initiate in real time bridge warnings through signs or other transmitted information, access control and traffic metering or total stop of bridge access through warning signs and physical gate or barriers. These alarms would also be transmitted to the central control or determined by the central control and downloaded to the local control.

The measurements are filtered and transmitted to the central control where they are stored and archived for analysis. The central controller will also check bridge functionality and performance on a real time basis but also determine the life cycle performance of the bridge and determine the life cycle based on the real updates of use based on actual measurements for the specific bridge. Analysis will use learning techniques to adapt to the unique design and load conditions of each structure. This will reduce the need to individually tailor analysis to each structure and will also have the additional benefit of identifying conditions that would be missed by the detailed analysis that presumes certain operating characteristics. Analysis will also support the need for scheduled maintenance and projected end of life for the bridge.

The central software and control will analyze a set of bridges to determine both short term, medium and long term operating requirements and support optimal scheduling and execution of tasks to improve the performance of the entire bridge system. The short term task such as snow removal, traffic metering on roads, or safety response to emergency such as identification of a vehicle involved in a crime or amber alert. Medium term tasks such as preventive maintenance, bridge light replacement, painting can all be analyzed and coordinated through the central software system to improve overall performance of the bridge

Long term each bridges life cycle will be analyzed for each specific bridge and determined based on levels of usage and measurement of bridge structural integrity and wear. The projected end of life date and safety factor will be determined through bridge structural modeling and engineering. The health or integrity of an entire set of bridges will be determined and updated. This information can be used to determine replacement and maintenance budgets.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments in which the principles of the invention are utilized and the accompanying drawings of which:

FIG. 1 depicts the main components of a system for measuring, monitoring and controlling the performance of infrastructure and specifically bridges according to the present invention. This system also creates a database for analysis of real time performance and learning through adaptive algorithms allowing the performance to be analyzed over time and for changes in performance against the specific bridge and other bridges in the bridge network.

FIG. 2 is a simplified diagram showing an exemplary remote central control station according to the present invention

FIG. 3 is a simplified diagram showing an exemplary local control unit according to the present invention

FIG. 4 is a simplified diagram showing an exemplary sensor module.

FIG. 5 is a block diagram showing information flow between a remote central control station and various information input sources and local control units that are on multiple bridges.

### DETAILED DESCRIPTION OF THE INVENTION

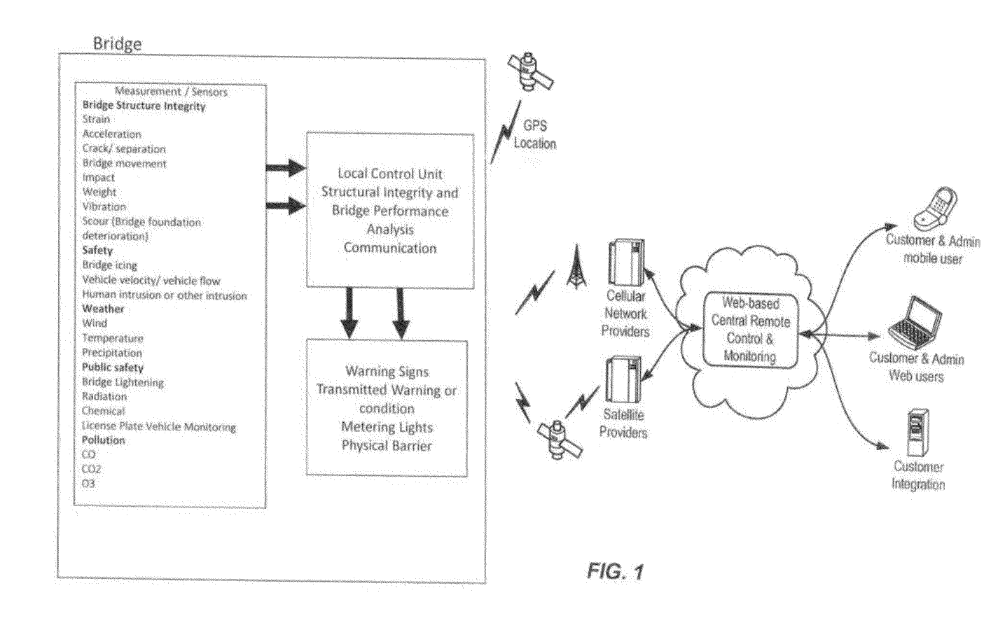

FIG. 1 depicts the main components of the system. A bridge for transportation is equipped with a local control unit. The local control unit can be permanently installed and fully integrated into the bridge or can be temporarily installed for short term or one time or periodic aligned with scheduled inspections monitoring and testing of the bridge for modeling and determination of bridge integrity (“health”), use and safety.

The local control unit must receive power to operate which is either produced locally through solar, wind of other generating source or obtained by connecting directly to the power grid. This power can also be stored in batteries or devices such as super capacitors for backup. The local control unit interacts with one or many sensors to measure conditions on or near the bridge for structural integrity, safety, weather, traffic, public safety, pollution and other conditions that are useful.

The local control unit can store, analyze, the measurements from the sensors and apply logic to determine local issues and safety concerns as well as transmit the measurements and data to the central remote control and monitoring station. The data could be filtered and combined or analyzed using adaptive algorithms with other data to determine the operating state of the structure.

A local control unit will communicate with local sensors or sensor modules. A local control unit can be a single sensor combined with the features of the local control unit in FIG. 1). A sensor can communicate through a wire, optical fiber or wireless method. A sensor will receive power either directly through cable or through an individual power source such as solar cell or wind generator. A sensor module will consist of one or more sensors, a power source and a communication method. A sensor module can be self-contained and include some of the functionality of a local control unit. For instance a single sensor with power, communication, GSM or Satellite antennae and processing can measure, filter and communicate information directly to the central remote monitoring and control station and act as a single node in a bridge performance network.

The local control unit is equipped with wireless communication modems and can communicate with a central remote control and monitoring station through publically available communication networks like cellular telephone networks, satellite networks and the internet. An exemplary embodiment supports communication networks through GSM, cellular networks and through the Iridium satellite network and the data would be routed from the cellular network and satellite providers to the central remote control and monitoring station via the public internet.

The local control unit also provides data on a specific bridge to the central system that is used to create a database for analysis of real time performance and learning through adaptive algorithms allowing the performance to be analyzed over time and for changes in performance against the specific bridge and other bridges in the bridge network.

Information from the local unit sent to the central unit would provide local operating conditions that could be correlated with other local bridges and allow information to be sent back to the local bridge. This information flowing in reverse for example could get information from owners about what actions they took on structures and use this to build a system to predict or recommend actions based on a network of bridges each with a local controller. For example, when did the bridge operator apply deicing or resurface the structure.

The local control unit would send information about the conditions of the bridge and measurements of the real time structural integrity, safety, weather, traffic, public safety, pollution and other conditions that are useful and about events it detects to the central remote control and monitoring station at regular intervals and in response to specific events (e.g. bridge collision, bridge physical shift off a bearing, etc) The central remote control and monitoring station can send data and commands back to the local control unit, either in response to a message from the unit or asynchronously as needed. The data from the central remote control and monitoring station can include set points for local control parameters like set points (ex. bridge de-icing heaters), and operation mode, thresholds for locally detected alarms, and control operation commands (ex: close gate to stop traffic due to bridge structure safety issue), as well as updated or fully new versions of the local control algorithms.

The central remote control and monitoring station can monitor and control many local control units simultaneously. It processes and stores the data sent from the local control units to enhance or filter the original information e.g. sensor measurements, normalization, trends, statistics) detect abnormal conditions through single point measurements (e.g. bridge movement), combination of multiple measurements and logic (e.g. bridge icing measurement, local temperature, local humidity and precipitation combined evaluated through an algorithm), or through a combination of multiple bridge local control data (traffic flow reduction combined with audio and regional weather information or regional river flow to determine accident location and suggested routing information). The central remote control monitoring and control station can detect events of interest, generate reports, and send user notifications and bridge control signals. It provides a user interface that authorized users can access via the public internet, through mobile application or through a web browser, as well as mechanisms to integrate with the back-end applications from multiple partners such as road plowing services, bridge maintenance and repair contractors, local police and fire departments.

The central remote control and monitoring station can send data and commands to one or more local control units based on a user action automatically in response to some information sent by one of the local control units or based on a command it received from a partner back end application. These user-initiated or automated commands can be based on a number of factors including weather, environmental or safety.

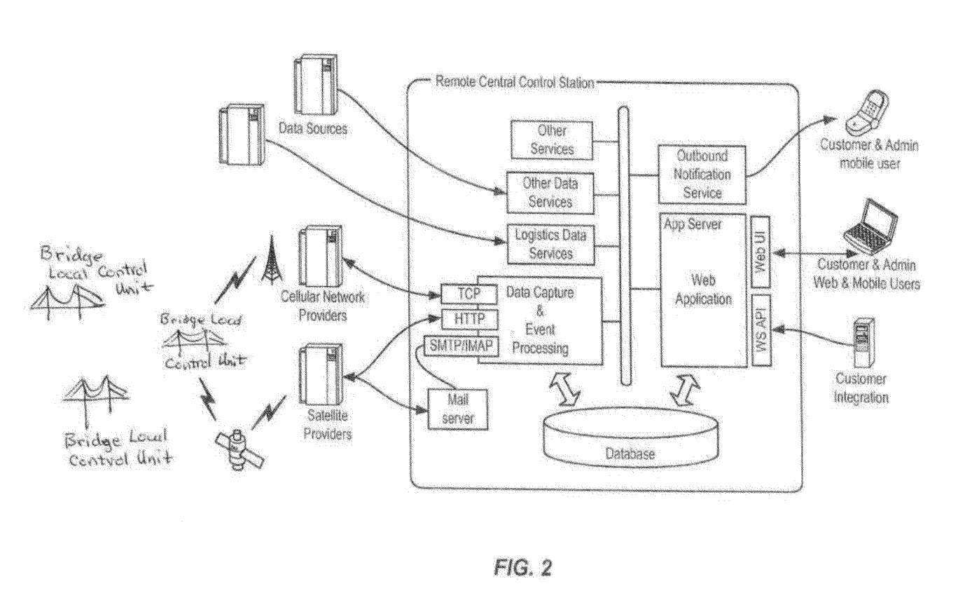

FIG. 2 illustrates an exemplary cloud-based remote central monitoring and control station useful in the system and methods of the present invention. The remote central control station can be hosted in a provider's or users data center or can reside at least partially in the cloud and will provide a number of data processing components typical of large web-based data control services. A remote central monitoring and control station will receive data from outside data sources, including weather information, traffic information, and the like. The remote central monitoring and control station will also be configured to communicate through all conventional data transmission services including cellular networks, web-based networks, satellite providers, and the like. Such communication links will serve to connect to the local units optional intermediate control units, and other systems. The communication links will also permit communication from users, partners, suppliers and other people involved in the performance of the structures.

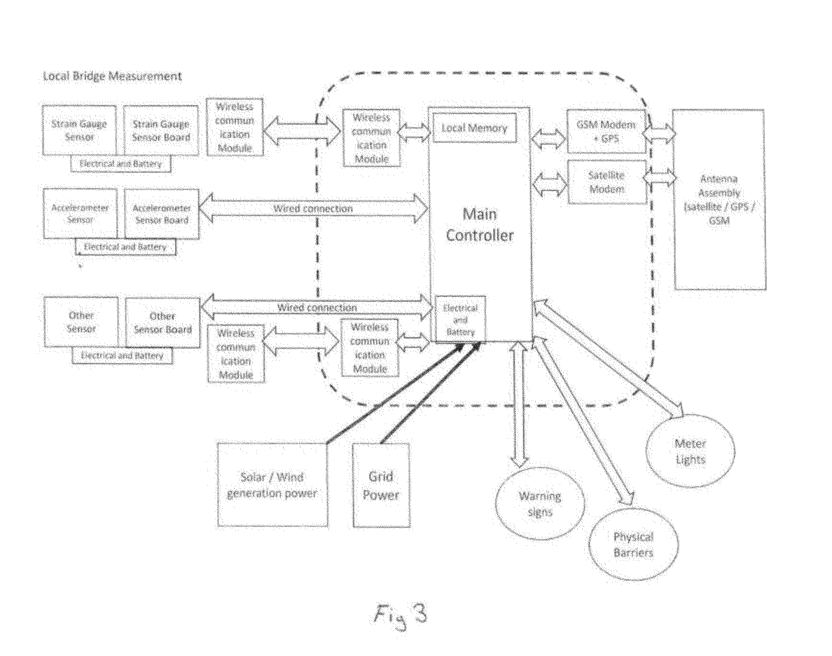

FIG. 3 illustrates an exemplary local control unit which is configured to mount on or near the bridge. The local controller will typically further interface with sensor that measure the bridge structural integrity, bridge safety, environment and weather and other parameters useful to the performance of the bridge. The local controller can act on measurements that indicate problems and send an emergency signal to the central control unit as well as take local action such as turning on a traffic metering light or to lower a gate that restricts traffic from traveling on the bridge. The local monitoring and control unit will also typically include conventional data input and output ports as well as radio devices to allow communication with the external interfaces and in particular to allow communication with the remote central control station and any intermediate control receivers and stations which might be employed. The local unit could also communicate with vehicles directly including conventional and autonomous through a defined interface. The local control unit will include a GPS receiver to notify and track its position.

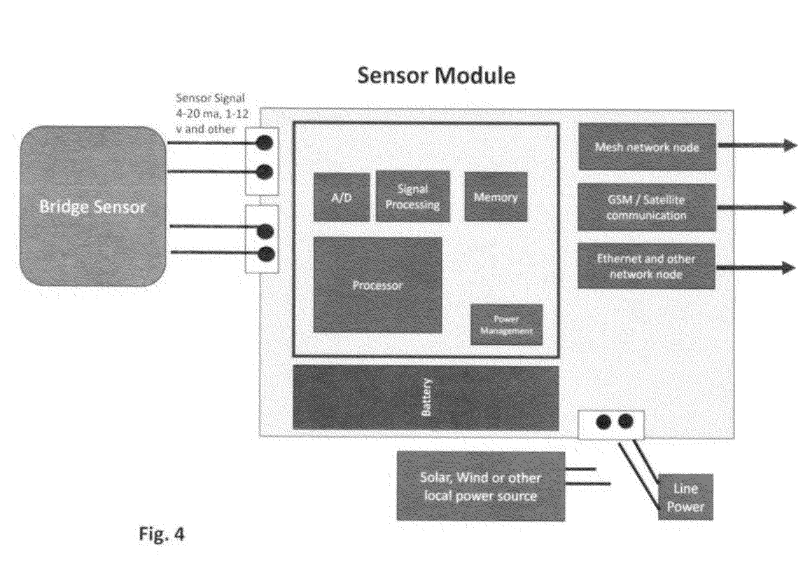

FIG. 4 Illustrates a single Sensor Module that would connect to various sensors and convert the measurement signal to a digital form, process and filter the signal, provide temporary storage for a set of measurements over time as a buffer, and transmit the signal to the local controller or directly to the central controller using various forms of data transmission. The sensor module could have battery back-up as well as receive power from a local power source or separate power generation unit.

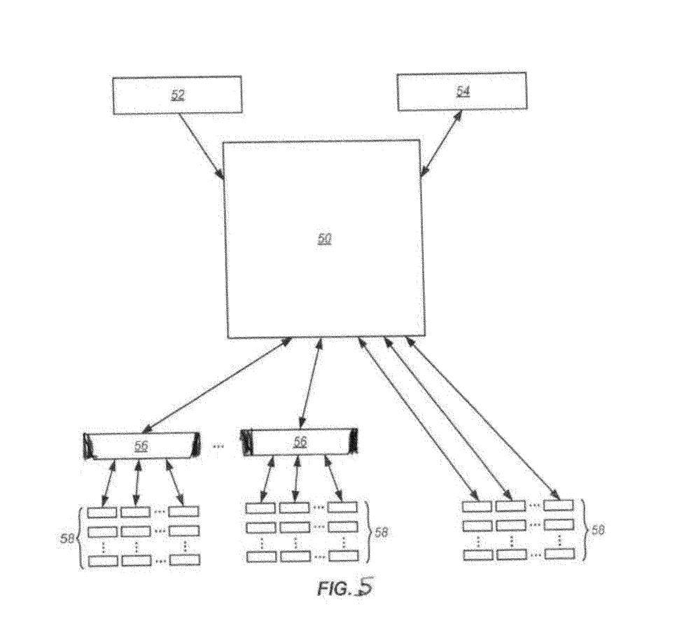

FIG. 5 illustrates a network of bridges or structures that is being monitored and controlled for performance in accordance with the principles of the present invention comprises, which is configured to receive data from external sources 52, such as databases showing weather, traffic, river water flows, and other information which may affect the operation, safety or other performance factors of the bridge. The remote central monitoring and control station will also be configured to receive input from users 54 regarding scheduling of maintenance, materials and the like. The remote central monitoring and control station will be configured to send and receive data to individual bridges 58 or structures or transportation vehicles. A network of bridges can be monitored and controlled for performance factoring any interaction between bridges (structures) or ways the bridges might be coupled to provide better performance.

### Examples

### Bridge Structural Integrity

Measurement from strain gauge shows exceeding defined limit—alarm

Dynamic response measurement from strain gauge shows exceeding defined limit—alarm

Measurement form crack growth shows exceeding allowable amount—alarm

Bridge movement exceeds a set limit due to earthquake—local control unit clears bridge and lowers gates to stop traffic

Bridge movement exceeds a set limit due to bearing damage

Detection of overweight truck on bridge by load cells—local controller turns on metering lights to lower traffic flow on bridge to maintain weight limits

Detection of an impact to the bridge structure from a truck hitting a support—alarm is set off to notify of impact, a signal is sent to local ambulance and police authorities and a maintenance task to inspect the bridge is added to the scheduling system in the central controller.

Scour: Foundation of a bridge is detected to be undercut by flowing water along with severe weather data and heavy precipitation with rising water level. An alarm is sent to central and the bridge gates are closed to eliminate bridge usage until inspected.

Bridge icing sensor shows increase along with precipitation measurement, and lowering local temperature. Bridge signage is activated along warning of icy conditions and bridge metering light activated to reduce traffic along with a change in speed limit.

Vehicle flow on bridge is indicated to be stopped or slow within parameters, time of day noted along with bridge strain indicating load on bridge. Other bridges in area monitored for traffic flow indicating other bridges available without traffic. Signals sent to autonomous vehicles or navigation systems in cars to reroute traffic.

Audible level and signature detected indicating a collision or accident. Alarm sent and authorities notified to respond.

Intrusion detected on bridge structure indicating abnormal behavior—video surveillance initiated along with alarm to authorities.

Degradation in bridge level of lighting measured indicating required maintenance on lights to assure good visibility and safety

Higher than threshold radiation detected on bridge, additional measurement of high weight vehicle detected indicating a potential radiation bomb or other abnormal event. Authorities alarmed at highest level, video surveillance initiated and vehicle license plate recorded and transmitted. Other bridges in region detect similar results with time delay indicating a direction and rate of velocity for tracking purposes. Live data feed to authorities for response.

Abnormal temperature gradient detected indicating a fire—fire suppression chemicals and process initiated, alarm and authorities notified.

Abnormal levels of chemical detected—alarm.

Pollution monitoring on bridge and correlated with all bridges in region indicating pollution levels.

### Bridge Health

Bridge structural sensors for a day, week, month, year are reviewed against a model to determine actual bridge life and number of cycles that the bridge has been exposed. Data used to predict remaining useful life based on actual bridge usage and bridge performance under this level of use. Using data engineering design of maintenance to effectively increase the life of the bridge based on known structural performance and comparison to a model.

Each specific bridge could be analyzed on an ongoing basis and an adaptive model and algorithms be used to model the structural performance of the bridge and how it is changing. In fact this becomes a learning bridge performance monitoring system as it analyses data over time and determines changes in dynamic and static responses to input or forces on the bridge. For example daily temperature changes could cause a different bridge signature for the same temperature as the bridge deteriorates or a change such as the impact of a truck on a support beam was induced.

In addition information from a network of bridges or a set of many bridges could be analyzed on an ongoing basis and an adaptive model and algorithms be used to model the structural performance of the set of bridges and how they are changing as similar structures or changing in different ways to various known inputs. A life cycle analysis could also be made from a set of bridges that are in different phases of life cycle and how predictions on performance could be made using information and analysis of a set of bridges that is shared.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that the methods and structures within the scope of these claims and their equivalents be covered thereby:

What is claimed is:

1. A method for determining structural performance, said method comprising;
collecting data real time from sensors on the structure;
comparing the data with a model of expected performance criteria to determine deviations; and
predicting future performance of the structure based of the pattern of deviations.

2. A method for using real time bridge conditions and environmental data collected from sensors on or near the structure and comparing that to models and set points of standard operation. If anomalies are discovered alarms and or physical intervention can occur to improve bridge safety.
